(19) United States
(12) Patent Application Publication
(10) Pub. No.: US 2004/0019393 A1
(43) Pub. Date: Jan. 29, 2004

(54) System and method for model base control

(76) Inventors: Eileen Heider, Budd Lake, NJ (US); Brian Gaida, Succasunna, NJ (US); Dave Gilson, Rockaway, NJ (US); Nat Frampton, Pearl River, LA (US); Mike Miller, Shreveport, LA (US); Harold Baird, Bossier City, LA (US); Erika Valentine, Blanchard, LA (US); Michael Bearden, Benton, LA (US)

Correspondence Address: U.S. ARMY TACOM-ARDEC, ATTN: AMSTRA-AR-GCL, BLDG 3, PICATINNY ARSENAL, NJ, 07806-5000, US

(21) Appl. No.: 10/064,542

(22) Filed: Jul. 25, 2002

(51) Int. Cl. G05B 13/02

(52) U.S. Cl. 700/31

(57) ABSTRACT

A model based controller system and method is disclosed. The system and method includes at least one model including at least one process step, at least one controller that generates at least one control command, at least one component responsive to the at least one control command, wherein the at least one component receives the at least one control command from the at least one controller, and wherein the at least one component sends at least one component information element to the at least one controller, and at least one communicative coordination that communicatively coordinates the at least one model with the at least one controller, wherein the at least one control command is generated in accordance with the at least one process step, and wherein at least one of the at least one process step is varied in accordance with the at least one component information element.

### FEDERAL RESEARCH STATEMENT

[The inventions described herein have been developed for, pursuant to, or with the assistance of, the United States government. These inventions may be manufactured, used and licensed by or for the United States government for United States government purposes.]

### BACKGROUND OF INVENTION

In current industrial, manufacturing, and data processing environments, process control is often necessary in order to ensure proper operation of a process. Process control may require the performance of a series of steps, such as in a particular order or at a particular time, in order to maintain a process within given tolerance levels, thereby ensuring process repeatability. Often, the result of a process is highly dependent on predefined tolerances subject to process control.

To this end, process controllers are often implemented in order to maintain processes within given tolerance levels. In a typical embodiment, a system is designed around controlling of hardware or software that directly controls a process. For example, control may be constructed around the programming of a physical component to perform step A at set point X, step B at set point Y and step C at set point Z. In such an embodiment, an error in the process that causes the non-occurrence of, for example, process variable 1 not reaching set point X, may cause the non-occurrence of, for example, step A, until the process controller is reprogrammed to look for an alternative set point in order correct the problem.

Such programming for error control may typically be performed by a process engineer, which process engineer must be familiar with the particular programming language of the control unit at issue, and must further be aware of where the error problem has arisen within the code of that controller. The process engineer may then model a correction patch, and must then generate program code, in the correct language of the control unit at issue, for entry into the control unit by hard coding, in order to correct the error problem. In this scenario a model is a mathematical algorithm that results in the suggestion of a corrected path based on inputs of the current process state. Thus, a process engineer must generate a model for correcting the error, must turn that model into the proper coding language, and must enter that coding language directly into the controller. Such a methodology of error correction requires extensive training for process engineers, and requires a great deal of human interaction and training in order to maintain processes within given tolerances.

Thus, the need exists for a controller environment in which a model may be developed, and universally coordinated with a controller, without a requirement for extensive training or interaction from a process engineer. Such a system may preferably provide for the development of a computerized model, wherein the computerized model, via a coordination interface, may intelligently select when control is necessary, and may interface with a controller operating in any controller language upon sensing that the model operation is necessary.

### SUMMARY OF INVENTION

The present invention is directed to a model based controller system comprising at least one model including at least one process step, at least one controller that generates at least one control command, at least one component responsive to the at least one control command, wherein the at least one component receives the at least one control command from the at least one controller, and wherein the at least one component sends at least one component information element to the at least one controller, and at least one coordination that communicatively controls the at least one model with the at least one controller, wherein the at least one control command is generated in accordance with at least one process step, and wherein at least one of the at least one process step is varied in accordance with the at least one component information element.

The present invention also includes a method of using a model based controller system to control a physical process where the process includes generating at least one model including at least one process step; issuing at least at least one control command from at least one controller; receiving, by the at least one component, at least one control command from said at least one controller; sending, by said at least one component, at least one component information element to said at least one controller, a response to the at least one control command, and generating at least one coordination that communicatively controls said at least one model with said at least one controller, wherein the at least one control command is generated in accordance with at least one process step, and wherein at least one of the at least one process step is varied in accordance with the at least one component information element.

These and other advantages and benefits of the present invention will become apparent from the detailed description of the invention hereinbelow.

### BRIEF DESCRIPTION OF DRAWINGS

The invention will be better understood with reference to the following illustrative and non-limiting drawings, in which like references there-throughout designate like elements of the invention, and wherein:

FIG. 1 is a block diagram of an aspect of the present invention;

FIG. 1A is a block diagram of an aspect of the present invention;

FIG. 2 is exemplary screen shots of an aspect of the current invention;

FIG. 3 is an exemplary screen shot of an aspect of the present invention;

FIG. 4 is an exemplary screen shot of an aspect of the present invention;

FIG. 5 is a block diagram of an exemplary flow of an aspect of the current invention;

FIG. 6 is an exemplary screen shot of an aspect of the present invention;

FIG. 7 is an exemplary screen shot of an aspect of the present invention;

FIG. 8 is an exemplary screen shot of an aspect of the present invention;

FIG. 9 is a block diagram of an aspect of the present invention;

FIG. 10 is a chart illustrating a list of exemplary components of an aspect of the present invention;

FIG. 11 is a block diagram of an aspect of the present invention;

FIG. 12 is a flow diagram of an aspect of the present invention;

FIG. 13 is a list-diagram of an aspect of the present invention;

FIG. 14 is a list-diagram of an aspect of the present invention;

FIG. 15 is an exemplary screen shot of an aspect of the current invention;

FIG. 16 is an exemplary screen shot of an aspect of the current invention;

FIG. 17 is an exemplary screen shot of an aspect of the current invention;

FIG. 18 is an exemplary screen shot of an aspect of the current invention;

FIG. 19 is an exemplary screen shot of an aspect of the current invention;

FIG. 20 is a screen shot of an opening of an exemplary application of the current invention;

FIG. 21 is an exemplary screen shot of an aspect of the current invention;

FIG. 22 is an exemplary screen shot of an aspect of the current invention;

FIG. 23 is an exemplary screen shot of an aspect of the current invention;

FIG. 24 is an exemplary screen shot of an aspect of the current invention; and

FIG. 25 is an exemplary screen shot of an aspect of the current invention.

### DETAILED DESCRIPTION

It is to be understood that the figures and descriptions of the present invention have been simplified to illustrate elements that are relevant for a clear understanding of the present invention, while eliminating, for purposes of clarity, many other elements found in a typical control system and method. Those of ordinary skill in the art will recognize that other elements are desirable and/or required in order to implement the present invention. However, because such elements are well known in the art, and because they do not facilitate a better understanding of the present invention, a discussion of such elements is not provided herein.

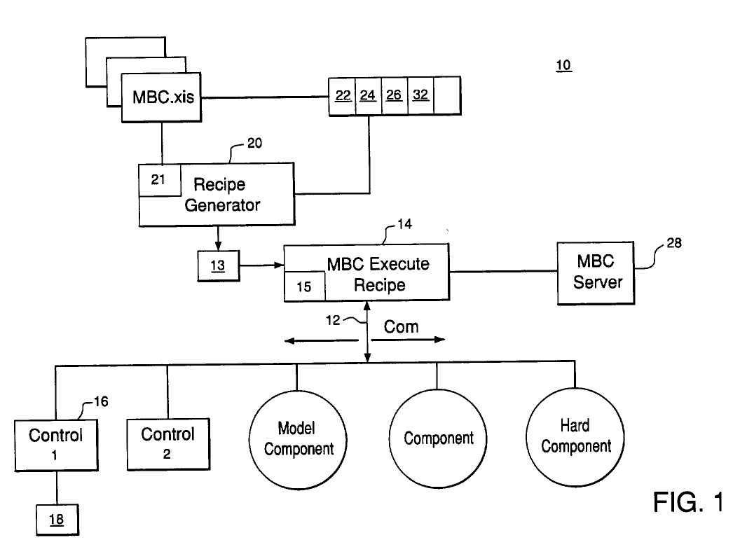

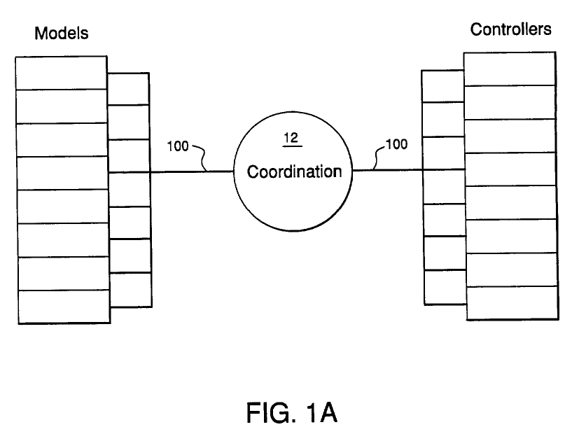

FIG. 1 is a block diagram illustrating a model based controller (“MBC”) system 10 in accordance with the present invention. The MBC system (10) may provide a coordination environment 12 that coordinates information flow, such as data flow, between at least one model 13 and at least one controller 16, which controller 16 may control at least one additional component 18. The MBC (10) may include a plurality of environments, such as an execution environment 14 and a development environment 20, and thus may include an application integrated development environment (“IDE” or “AIDE”) (21) within the development environment (20), and at least one execution platform (15) within the execution environment. Within, or associated with, the IDE 21, the MBC 10 may additionally include a framework 22, a runtime platform 24, a recipe generation and/or edit platform 26, and at least one server 28, such as a coordination environment server. The at least one server 28, or server programs associated with the server, may be platform and/or operating system independent, such as OPC, DCOM, or XML. The development environment (20) and execution environment 14 may additionally include other facilities to control simulated or hardware components for, for example, real time control.

The coordination environment 12 may be, for example, a server, or software thereon, such as an interface, that coordinates the data flow between the at least one model 13 and the at least one controller 16. The coordination environment 12 receives and processes commands from the model 13 to control the controller 16, and receives and processes information received from the controller 16 for placement into the model 13, thereby allowing the model 13 to monitor and control a process via the coordination environment 12.

FIG. 1A is a graphical illustration of a coordination environment 12 in accordance with the MBC system 10 of FIG. 1. The coordination environment 12 may coordinate at least one of a plurality of models such as 13 with at least one of a plurality of available controllers such as 16, as set forth hereinabove, such as over a network 100, and such as by the at least one server 28. For example, the at least one model 13 may be one of a plurality of models within a recipe, and the at least one controller 16 may be one of, for example, a plurality of programmable logic controllers each having alarms and/or controls associated therewith, or one of a plurality of input-output (I/O) ports within, or associated with, a programmable logic controller, for example. The at least model 13 may be remote from at least one of the coordination environment 12 and the control level 16, and each element of the MBC 10, namely at least the model 13, coordination environment 12, and the control level 16, may exist in hardware or computer programming, such as on the at least one server 28, with the at least one server 28 capable of remote communications, such as over a network, such as the internet. Thus, the ability of the MBC 10 to control a process, or to engage in logic, may be a function of the data rate capabilities of the network, servers, and the like, associated with the MBC 10.

Returning now to FIG. 1, the development environment 20, such as the IDE 21, may allow for the development or review of a pre-existent recipe or a recipe generated from, for example, the recipe generation platform 26, for execution on the execution platform. Thus, the development environment 20 may allow for attachment directly to a running controller 16, or over a network to a running controller 16, for review and editing of the pre-existent recipe on that running controller 16, or may allow for creation of a new recipe to run the at least one controller 16. The development environment 20 preferably treats a controller 16 as an object for control by at least one model 13, thereby eliminating the need to hard code selected set points into the controller 16 itself. In this manner the development environment 20 can use the model 13 to vary the controller 16 as an object, and after the desired set points. The relation of the model 13 to the controller 16 as an object makes obvious to a user, such as a process engineer, the coordination between the controller 16 and the model 13, unlike the hard coding relationship of the prior art.

The IDE 21 may allow for extensions, via a component object model such as a (COM) or a XNL Services, for example, to enable the control of numerous different components via the same, or an associated, MBC 10. The development environment 20 may, for example, present a plurality of selectable components or preexistent models, as discussed further hereinbelow, which may, for example, be dragged and dropped into a developing recipe project. The development environment 20 may include, for example, programming in Visual Basic, Visual C++ such as a (COM) or a XNL Services and/or Microsoft Windows 2000 Professional.

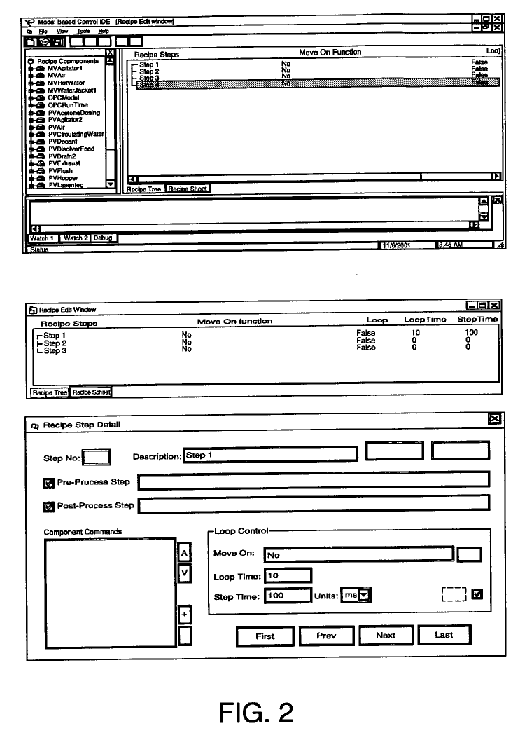

The development environment 20 may additionally include, such as within or associated with the IDE 21, a recipe edit platform 26 of the IDE 21, which may allow the viewing and editing of at least one running recipe, or of at least one recipe project created within the IDE 21. The recipe edit platform 26 may allow, for example, the entry of multiple recipe steps, the reordering of steps, pre and post step work, looping and branching control, timing controls, and the like. The recipe edit platform may allow for drag and drop, right click menus, pop up menus, or menus displayable by activation of, for example, functional keyboard keys, which menus may include help instructions to perform functions within a recipe, editing or monitoring of time for a loop within the recipe or for a step within the recipe, and/or tabbed views, such as a recipe tree, a recipe sheet, and/or a recipe code window, for example. Each step within the recipe may be accessible within a window for editing of each recipe step, as illustrated in the exemplary screen shots of FIG. 2.

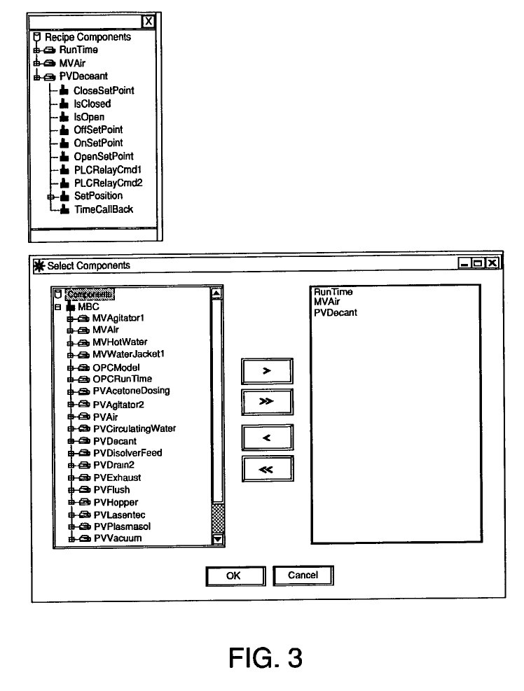

Returning now to FIG. 1, the development environment 20 may further include, for example, a component browser 32. The component browser 32, as illustrated in the exemplary screen shots of FIG. 3, may display the components have been, or may be, selected for a current recipe project in development. The component browser 32 may allow for selection of components, or operational methods for components, for use in recipe steps, and/or for selection of components or component properties for display within certain windows. These display windows may include a watch window for watching an ongoing or active recipe, which watch window may illustrate, for example, true or false real time status of at least one selected recipe step condition, or a data collection window for watching active data accumulation, which data collection window may provide a capability to save data, such as a non-overwriteable date/time stamped save. The component browser 32 may provide a tree representation of components, for example, and may additionally provide the methods and/or properties of the components, including, for example, the component parameters, data types and/or property data types, of the displayed or selected components.

The development environment 20, and/or the execution environment 14 may share a simulator, wherein the simulator may include the operational methods of a plurality of hardware elements. A recipe may be developed using the available simulated hardware components, which simulated components, upon execution of the recipe, will provide feedback that simulates the actual hardware that provides the basis for the simulated hardware. The behavior of the simulated components may be experimentally defined, such as by monitoring of actual hardware and saving performance data to simulator files. These simulator files may then be accessible to, or downloaded to, the MBC 10 as selectable components.

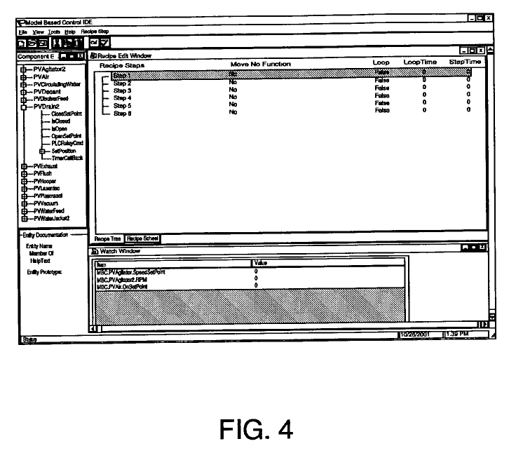

FIG. 3 is an exemplary screen shot illustrating component selection available within the component browser 32. Components may be selectable, for example, using point and click methodologies, treed methodologies, file menu methodologies, or may be imported via, for example, drag and drop and/or right click methodologies. The component selection module within the component browser 32 may allow for selection of components recognized by, and/or registered with, the operating system or the MBC as MBC components, and may allow for component selection for recipe projects. In the treed format illustrated in FIG. 4, component libraries, and components included therein, may be selectable from the tree. Component selection may be used during recipe creation, or when adding components to an existing recipe.

The framework 22 may provide the functionality within the environments of the MBC 10, such as the development environment 20 and the execution environment 14. For example, the framework 22 may provide Open/Close/Save for recipe projects, or recipe files, within a recipe; the addition, or undo, of at least one component to a recipe; drag and drop, and/or cut and paste, from window to window within the MBC, and/or to or from exterior applications via, for example, importation to the MBC 10; execution command for running at least one recipe; debug of components or at least one recipe; Open/Close for windows such as recipe watch, data collection, recipe viewer, etc.; and support, such as at least one help menu. In order to provide these functions, the framework 22 may include system menus, system help, IDE window coordination, and/or toolbars, as will be apparent to those skilled in the art. Further, as used herein, toolbar, single arrow, double arrow, file menu, drop down menu, hyperlink, tab menu, or treed menu, for example, may be used interchangeably unless therwise noted, and are provided by the framework 22. In an exemplary embodiment of a window provided in the framework 22, FIG. 4 is a screen shot illustrating primary interfaces for a recipe development session, such as within the development environment 20.

Each recipe developed and/or executed in the present invention may implement at least one model 13, as discussed hereinabove. Each recipe that includes the at least one model 13 may monitor at least one method, process, or data flow, for example, wherein each model 13 within the recipe may control and/or monitor at least one aspect of the method, process, or data flow, for example. For example, a recipe may be generated to control the growth of a given crystal. Each model within the recipe may then monitor and/or control a particular aspect of the growth of the crystal.

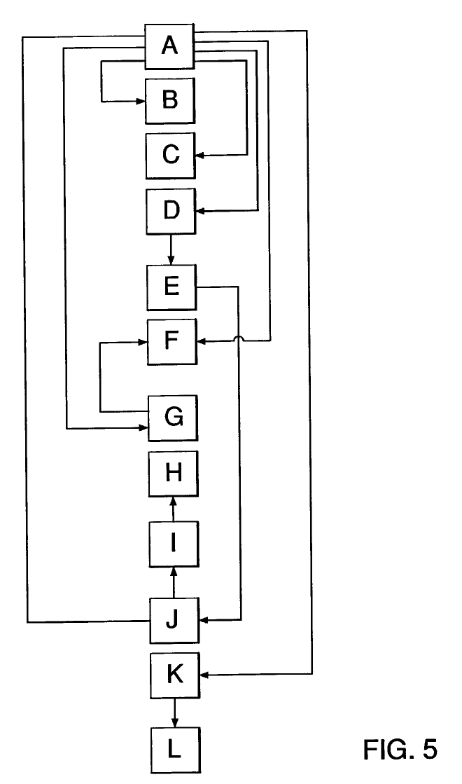

In this exemplary embodiment, the crystal may grow over time, preferably within a given tolerance for growth rate, which tolerance is monitored and controlled with improved consistency through the use of the present invention. For example, as illustrated in FIG. 5, a recipe A including twelve models that control the growth of the crystals, which recipe A may, at predetermined times, and/or at predetermined intervals, call models B and C, wherein models B and C may monitor particular aspects of the given crystal growth within the process controlled by master recipe A. Thus, for example, if model A monitors that the crystal growth is occurring too quickly, recipe A may run model F, wherein model F may provide process temperature change suggestions in order to bring crystal growth back within tolerance levels. However, for example, if recipe A monitors that crystal growth is occurring too slowly, recipe A may run model G, wherein model G may suggest the input of a particular gas in order to stimulate growth of the crystal, and wherein model G may call model F to suggest temperature changes to stimulate crystal growth. Additionally, as will be apparent to those skilled in the art, recipe A may then call model D, model E, and model J, each individually, in sequence, or all simultaneously, such through the use of object oriented programming. Thereby, the recipe may provide real time process control over the growth of the crystal, and tolerance levels may be maintained more consistent throughout repetitions of the process through the use of the same coordination environment.

Thus, the recipe may operate heuristically in order to maintain the process at predetermined tolerances. For example, although a given model may include that process occurrence X occurs at motor speed 30 RPM, the model may be alerted by the control that X has occurred at motor speed 22 RPM, and may vary the process accordingly pursuant to an understanding that occurrence X is the goal, rather than the assertion that condition motor speed 30 RPM would accomplish X. Further, those skilled in the art will appreciate that, in accordance with this methodology, steps within a first recipe or first model may be responsive to, or dependent on, steps within a second recipe or second model, wherein the first recipe or model is in communicative connection with the second recipe or model via the MBC coordination environment.

Each model within the recipe may pass information through the coordination environment to an I/O port, or to a programmable logic controller. Further, as set forth hereinabove, a plurality of models may be coordinated with a plurality of controllers via the coordination environment. Each I/O port, or each controller, may then be responsible for controlling a particular aspect of a process, such as the crystal growth environment discussed hereinabove. In prior art embodiments, different models or types of I/O port, or different types or models of controllers, such as programmable logic controllers, may have been substantially unable to directly interface with one another in order to provide uniform and overall process control across the different models or types. This inability to interface often occurs in the prior art due to the use of different brands, or types, of controllers, which may, for example, employ different interface capabilities or computer programming language capabilities, and this inability to interface is remedied, in part, through the use of the present invention.

Thus, the coordination environment of the present invention allows for multiple controllers, each of which may operate in accordance with a different operating environment, which different operating environments may be remote from the coordination environment 12 and/or the model environment, to operate in unison in accordance with at least one model 13 or recipe communicating through the coordination environment 12. Additionally, the present invention allows for the replacement of equipment, or controllers, within the controller environment communicating through the coordination environment 12. For example, two models programmed with the tolerances, and technical aspects, of each of the old and the new equipment, respectively, may be adjusted accordingly for the incorporation of the new equipment without substantial variation to the recipe. This switching between models within the recipe may be engaged, for example, by the process engineer, upon installation of new equipment, without any substantial reprogramming by the process engineer. Thus, the process engineer need not know the nuances of the model or models run within the recipe, but rather need only know the equipment or controllers availabe in the controller environment communicating through the coordination environment, and need only instruct the coordination environment 12 as to the presence of particular equipment or controllers in communication with the coordination environment 12.

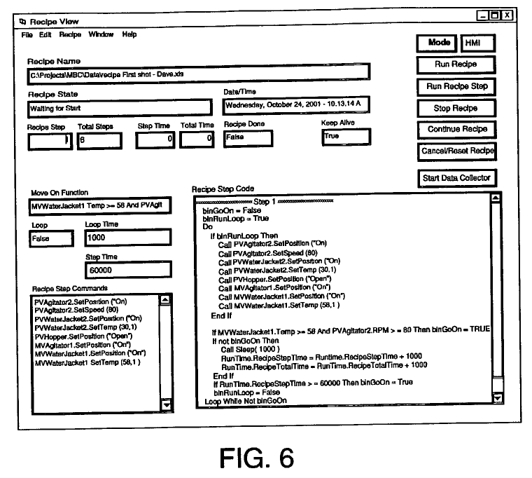

Returning now to FIG. 1, the execution environment 14 may include, for example, the ability to monitor the running of a recipe in run-time, and/or to interactively monitor component property values during execution, and/or the ability to monitor and/or collect data during run-time. For example, FIG. 6 is a screen shot within the execution environment 14 illustrating a viewer for viewing the run-time of recipe. In the exemplary embodiment illustrated, material viewable from within the recipe run-time viewer may be included, and/or presented, within a COM library, such as a library denoted “recipe interface”. The run-time viewer may be a stand alone application, for example, or may additionally be integrated with, or within, the IDE 21.

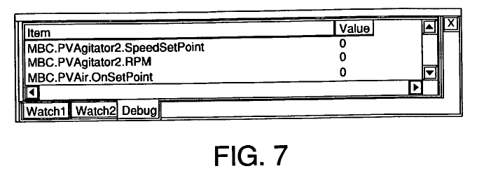

In this exemplary embodiment of an execution environment, the viewing of run-time component property values may be enabled through the use of a watch window, such as that illustrated in the screen shot of FIG. 7. The watch window may be, for example, a dockable or floating window that enables a user to monitor component property values, such as during run-time or debugging. The watch window may additionally include a plurality of tabbed views, wherein varied watch configurations may be made available by clicking on selected ones of the tabs. As used herein, one skilled in the art will appreciate that tabs may include, for example, selectable drop-down menus, point and click menus, hyperlink menus, and the like.

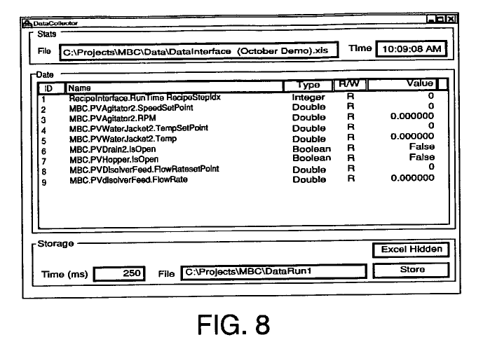

Additionally, in this exemplary embodiment, a data collection window may be included in the execution environment, such as that illustrated in the screen shot of FIG. 8. The data collection window may be a dockable or floating window that enables the monitoring and/or storing of component property values during recipe execution. The data collection window may include, for example, tabbed views similar to those discussed hereinabove with respect to the watch window. The data collection window may, for example, collect data and allow for display of that data to a user at a predetermined minimum rate commensurate with the change rate of the data of interest, such as, for example, at least once ever two seconds. Data collection capabilities accessible via a data collection window during run-time may include, for example, file compression, storage to at least one file types, such as, for example, to a spreadsheet or .CSV file, and the data collection window may include a configurable storage directory.

Further, preferably within the watch window, the data collection window, or a storable file, applicable programming code for the recipe run may be made available and/or recordable, such as for review of the recipe run by an MBC user. For example, a run file may be created for the running of a particular recipe, which run file may be saved, for example, to the desktop. This methodology of file saving may allow, in an exemplary process, tracking of the time of occurrences in the recipe run at the shortest time frame provided by the computer operating system on which the run code is generated.

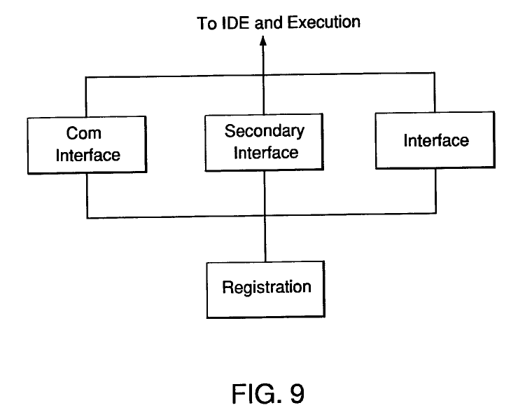

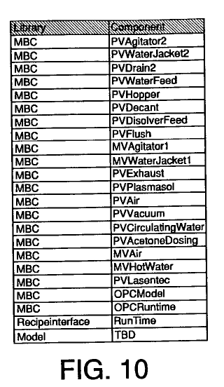

Each of the development environment and the execution environment preferably allows for the configuration and/or monitoring of the components, and/or libraries of components, employed in the recipes of the present invention. FIG. 9 is a block diagram illustrating an MBC component. An MBC component is any software or hardware item that provides, or allows connection to, an open interface, such as COM or XML Services, that self-registers, or that can be registered, with, for example, a Windows operating system environment, such that the IDE can locate the component during recipe development, and such that the execution environment can locate the component during execution. Further, the components of the present invention preferably implement at least one component interface. FIG. 10 is a chart illustrating a list of exemplary components, which may be available, for example, via an MBC component library.

Open Interface, such as COM or XML Service, as used herein, allows applications and systems to be built from components supplied by different hardware and/or software vendors. COM or XML Services may be an architecture employed to form foundations for higher level software services. Higher level software services may span varied aspects of component software, such as compound documentation, custom control, inner application scripting, data transfer, and the like. COM or XML Services is an architecture that defines a binary standard for component interoperability, is programming language independent, may be provided on multiple platforms, provides a robust environment for evolution of component based application and systems, and is extensible, as will be apparent to those skilled in the art. In addition, COM and XML Services may allow for communication between components, such as across process or network boundaries, shared memory management as between a plurality of components, error and status reporting for components, and the dynamic loading of components.

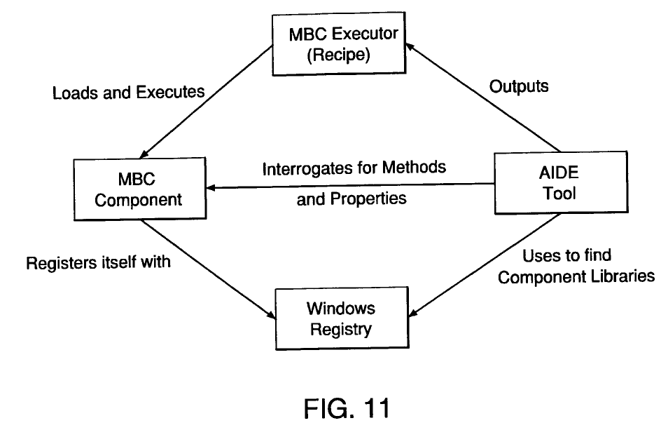

Returning now to FIG. 9, an MBC component is a building block within the MBC system. An MBC component is present within the IDE in order to allow for the creation of recipes, for example, and an MBC component is executed within the recipe upon execution in the execution environment, as discussed hereinabove. An MBC component may exist, for example, as a COM object within a COM library, or as a stand alone XML Service, as set forth hereinabove. A component library may be, for example, a collection of classes that have implemented at least one open interface. It will be apparent to those skilled in the art that an MBC component may be implemented by an interface, such as by a secondary class interface separate from a first component interface, which secondary interface may allow the IDE 21, and/or a component configuration utility within, or in association with the IDE 21, to properly address MBC components in a uniform fashion. For example, FIG. 11 is a block diagram illustrating the addressing relationship between an MBC component and other MBC system elements.

In accordance with FIG. 11, an MBC component may register, or be registered, with the operating system registry, such as a Windows registry, such as through the use of a registration wizard, which registration wizard may respond either automatically within the MBC, or to a user request for component registration. For example, upon implementation of the IDE 21 or execution environment 14 or configurations, a search may be performed for components in the operating system registry, and that search may allow for the building of at least one MBC component library of registered components. The component list may then be made available to the recipe developer within both the IDE 21 and the execution configurations. Upon selection of a set of component libraries, the MBC components may be interrogated, via, for example, the COM or XML Service interfaces respectively, to assess the method, properties, and configuration of each MBC component. Within the IDE 21, the MBC components may be presented as a selectable list of available libraries, such as for different tasks, recipes, or model types, wherein each library may contain the methods, properties, and configurations then used to create recipes.

In addition, it will be apparent to those skilled in the art that new communication elements or types, unknown by the registration wizard, may be programmed into the registration wizard. For example, in an embodiment wherein a particular device communicates serially, such as directly with a PC, the registration wizard may be programmed to read a computer serial port in order to receive data from, and thereby allow for registration of, that serial device. This addition of new device types may include a hard coding of new device types, a file download of new device types, or a creation of new objects within an object-oriented environment for new device types, for example. It will be further apparent that, in an embodiment wherein, for example, a programmable logic controller (PLC) is capable of direct communication with the new device, such as the new serial device, and wherein the PLC is already registered as a component, the new device need not be registered as a component, but rather may be controlled by the MBC by exertion of control over the PLC to which the new device is communicatively connected.

In an exemplary embodiment of registration, selectable components may include hardware components, such as programmable logic controllers (PLCs), in certain embodiments of the present invention. These components that are and registreble with the MBC 10 may be automatically added to a list of eligible components upon communicative connection to the MBC, or upon a search for eligible components as described hereinabove, such as by an automated sensing of the communicative connection, a reading of the tags from a PLC upon the automated sensing, wherein the tags include information pertaining to communication protocols for the PLC. Upon the reading of tags and initiation of a COM object, the PLC may be registered and made available for recipe projects. The ability to automatically communicate with numerous controllers of different makes, models, or communication types provides interoperability across controller platforms in the present invention. Further, it will be apparent to one skilled in the art that this methodology may be extended, for example, to different kinds of hardware, such as sensors, valves, actuators, motors, and the like, inter-communicating with each other and one or multiple controllers, via the use of the component registration of the present invention.

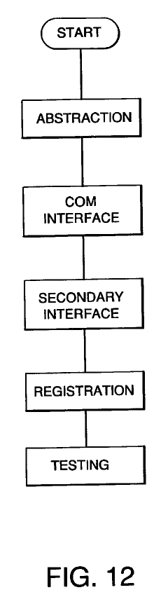

An MBC component may be formed and formatted using, for example, visual basic. FIG. 12 is a flow diagram illustrating the development of an MBC component, wherein the steps of the development may include creation of an abstraction for the component, the creation of a COM or XML Service interface for the component, the implementation of the secondary interface for the component, the registration of the component with the operating system, and the integration and testing of the component.

The first step of the development of the MBC component may be the development of an abstraction component. Upon completion of the development of the abstraction, a COM or XML Service interface may be created for the component. A COM or XML Service interface may be created in, for example, visual basic as, for example, an ACTIVEX DLL or EXE file. Project settings may determine the name of the component library, and the classes of the library may determine the components allowable therein. Thus, using visual basic, in order to create an MBC component and library, an ACTIVEX DLL or EXE file may be created for the project, and one or more classes may be added to the project. The name of each class may determine the name of the component, as will be apparent to those skilled in the art. Subsequently, methods and properties may be added to each class in order to implement the abstraction of the component developed hereinabove. References may be added for the MBC library and type libraries, and a DLL or EXE may be built.

The implementation of the secondary interface discussed hereinabove allows the MBC system applications, including the IDE 21 and the component configuration utility, to treat MBC components in a uniform way, as set forth hereinabove. The secondary interface methodologies and properties may not be visible from within recipes, such as during recipe development.

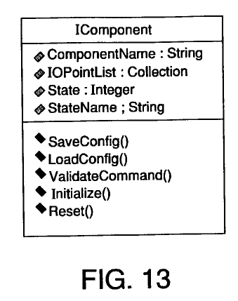

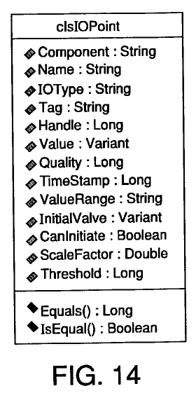

A UML diagram for an exemplary secondary interface is illustrated in FIG. 13. With respect to FIG. 13, a variable component name is a fully qualified name for the component, and includes the library of the component. The “I/O point list” may be a collection of I/O point objects, for example. “State” may be an integer value that represents the internal state of the MBC component. “State name” may be the string representation of the state of a given variable. “Save configuration” may be used to save a component's configuration, which may include the name of the component and the I/O point list of the component. “Load config” may be used to load a component's configuration. “Validate command” may be used to check the set point for an I/O point value against the I/O point valid range of values. “Initialize” may be used to initialize the component. “Reset” may be used to reset the component. An exemplary hardware point object list for an MBC component is illustrated in FIG. 14.

Additionally, the MBC component and component library may be registered with the operating system, as set forth hereinabove. This may be done, as will be apparent to those skilled in the art, via a variety of methods, including the creation of a key for registration. The registration key for, for example, the IDE tool, may include the values for persisting the state of the IDE tool, such as user preference values, window size and location values, and file list values. Each component may create its own key value for registration. Upon a registration, or an attempted registration, the component and library may be tested.

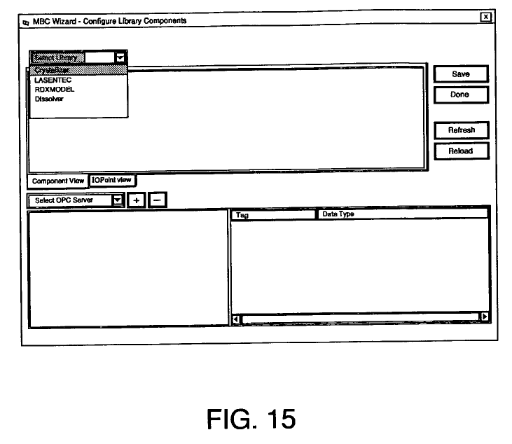

The component library may be tested, for example, by testing that the component is a valid COM or XML Service object, has implemented the secondary interface, has a correctly implemented an abstraction, and operates correctly with the IDE. The component library may be tested using the MBC configuration utility. Further, in order to test the components and component library, the library registration may be checked. FIG. 15 is a screen shot illustrating the testing of library registration. Wherein a component library is correctly registered with the MBC system, the component library or libraries may be displayed within the MBC component configuration.

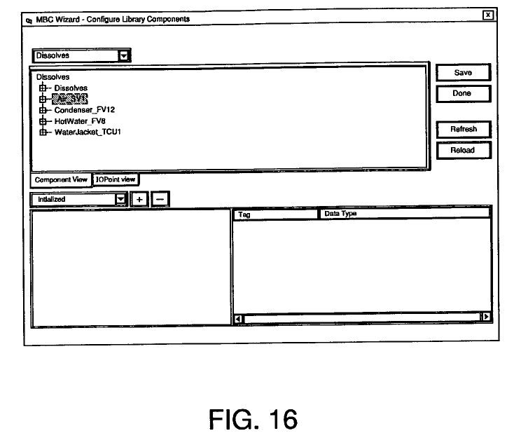

In order to test that a component is a valid COM or XML Service object, a library may be selected that contains a component in question from the library list, as illustrated in the screen shot of FIG. 16. Valid COM or XML Service objects may be displayed within the library, such as within the tree view of the library, as illustrated.

In order to test for the secondary component implementation, each object in a component library may be associated with a flag, wherein the flag is set to provide recognition that the secondary interface has, or has not, been implemented. an embodiment wherein the secondary interface has not been implemented for the selected component or component library, a warning message may appear.

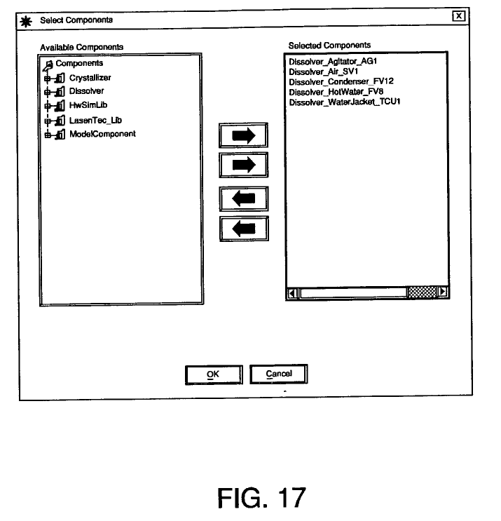

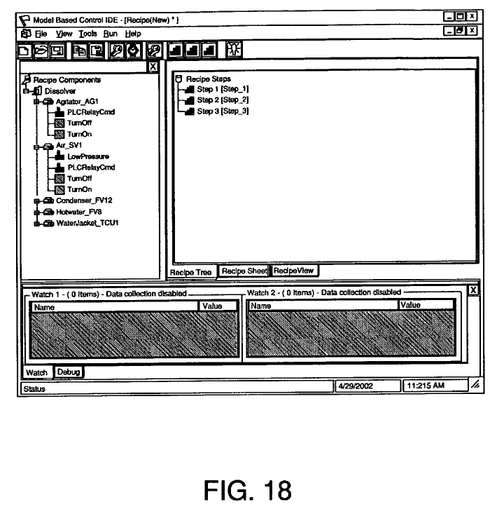

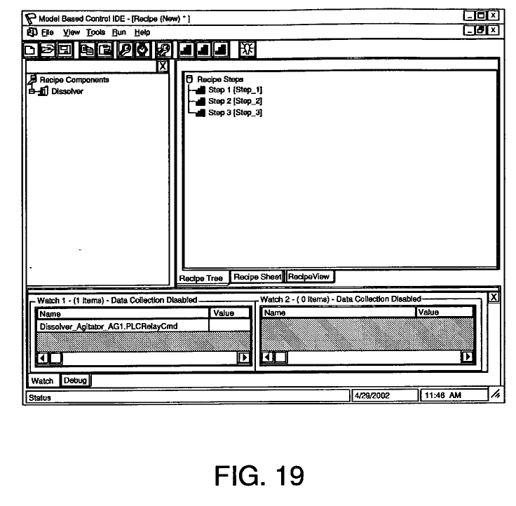

In order to test the component abstraction implementation, a subjective evaluation may be made, wherein the subjective evaluation may, for example, test the component within the IDE against, for example, a simulation, and may test the component again in, for example, the run-time environment. In order to test the component abstraction implementation in the IDE, the IDE may be started and a component library may be selected for checking of the component library methods and properties within IDE, as illustrated in the screen shot of FIG. 17. The abstracted components may then be tested in a recipe, such as that illustrated in FIG. 18. In order to assess the correct function of a component from within the execution environment, for example, a property of the component may be added to, for example, the watch window, as discussed hereinabove. If a component has been properly and successfully created, the property may display in the watch window as illustrated in FIG. 19. If the component was improperly created or constructed, an error message may appear.

In operation, the MBC system may include a developed recipe. The recipe may be developed by entering the IDE, and opening an existing recipe project, or by creating a new one. The recipe may be developed by the addition of components, the creation of recipe steps and/or recipe models, the addition of components to the recipe or model steps, and the collection of set-up data. The recipe may then be debugged, such as through the use of watch windows, the display of recipe break points, a review of captured data from recipe execution, or by troubleshooting the logic of the recipe. Following debug, a recipe may be saved, and/or deployed. The components for the recipe used may be developed using, for example, Visual Basic, Visual C++, Java, C# or Delphi, and the components developed are preferably registered with the operating system or MBC environment prior to use within a recipe.

Upon validation of the recipe, a process may be controlled, such as via a combination of a controller, and a model. The recipe may thus include the coordination between the controller and the model. The process may be dynamically controlled, or predictively controlled. With dynamic control, the recipe may set model input properties based upon process input data. The recipe may further call a model in order to calculate outputs based upon the model input properties, and may then update the model in accordance with output properties. The model outputs may then be used by the recipe to control the process. For predictive control, the recipe may initialize start-up parameters, and may call a model to produce predictive data for the running of the process. The recipe may then capture the model predictive data in, for example, a memory, such as a table. The recipe may then make calculations using the model predictive data, and may control the process in accordance with these calculations.

Thus, as set forth hereinabove, in order for the recipe to exercise predictive or dynamic control of a process, the recipe may be executed by the execution environment, such as by a recipe execution engine. Recipe execution may include the execution of the series or plurality of recipe steps, such as in the form of models as discussed hereinabove, which recipe steps may include, for example, component methods, pre and/or post processing logic, branching or got logic, move on conditions, loop indicators, loop times, and/or step times. The component methods may include at least one method call in accordance with a hardware component set point, in order to allow for control of that hardware component within predetermined tolerance levels. Preprocessing logic may be executed at the beginning of a recipe step. Post-processing logic may be executed at the completion of a recipe step. Preprocess and Post processing logic may redirect the recipe execution to a goto, or to branch to another recipe step. For example, preprocessing logic may compare a temperature reading and determine that a emergency flush of a container is appropriate. The preprocessing algorithm might, in this, exemplary embodiment, call a Goto function with the name of the recipe step that executes the emergency flush. Preprocessing or postprocessing logic may also branch to a series of steps and return to the original step upon reaching a return recipe step, for example. Move on conditions may, for example, include Boolean expressions that are evaluated in order to determine whether the recipe can move to a subsequent recipe step. For example, an expression may be developed that will allow for the running of a particular model until a predetermined condition is met, and, upon the meeting of that condition, another recipe step, or a different model, may be allowed to run. In an exemplary embodiment employing control of a motor, the recipe may not be allowed to move to a next step until the controller tells the model that the motor has reached a speed preset within the move on step, such as a certain number of RPM. Loop indicator may include a Boolean expression that determines whether the recipe can execute the component methods in a loop. Loop time may determine the execution frequency of a recipe step loop, and step time may determine the maximum duration of a recipe step.

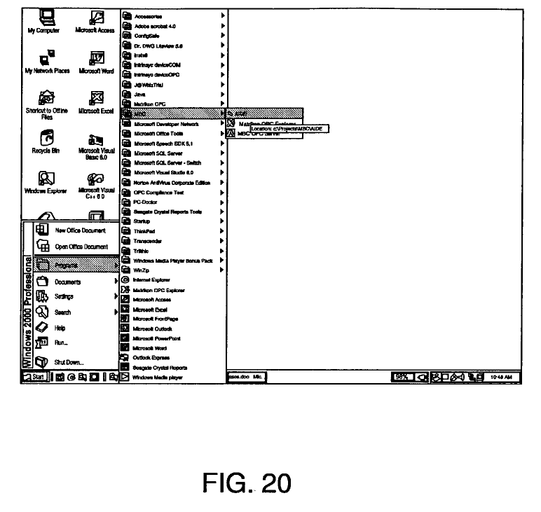

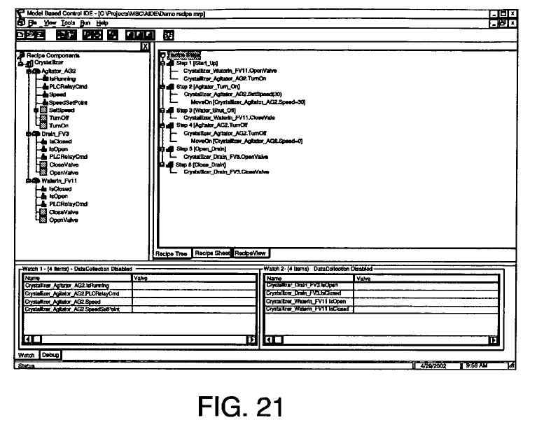

Also, as set forth hereinabove, in order for a recipe to be executed in the execution environment, the recipe may be developed in the development environment, such as in the IDE; FIG. 20 is a screen shot illustrating the opening of an IDE application. The IDE application may include a plurality, such as six, IDE components. The IDE components may include, for example, a recipe editor that creates, debugs, and/or prepares recipes to run, an MBC component browser to facilitate recipe creation, a watch window that allows for the viewing of recipe progress during debug, and a framework for inter-process communication and recipe development. An exemplary IDE layout is illustrated in the screen shot of FIG. 21. FIG. 21 illustrates a split layout, thereby providing increased user convenience. The exemplary split layout illustrated employs a tree layout of recipe components on the left-hand side of the screen, wherein the components displayed are components of the recipe step selected on the right hand side of the screen. The right hand side of the screen provides a tree layout of the recipe, including each of the plurality of models, or recipe steps. Information is given as to each of the plurality of recipe such as move on function to allow for selection of a proper move on point during execution, and a loop, loop time, and step time function for the selected recipe step. The IDE layout illustrated in FIG. 21 includes at least one watch window, wherein the watch window provides additional information regarding the recipe displayed.

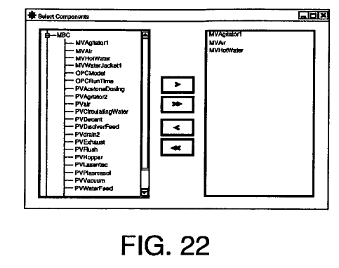

In this exemplary operational embodiment, a new recipe may be created, such as by selection of a new recipe project from a selectable menu within the IDE. The user may be allowed to interactively select components for placement into the new recipe project. The selection of components may be allowable by a screen shot similar to that of FIG. 22. Available components, such as those illustrated in FIG. 22, may be viewed by expanding component categories, such as through the use of a treed menu. Components may then be selected or removed, such as through the use of single arrow buttons, double click, or the like. All components may be selected, or removed, simultaneously, or by category, for example, such as through the use of a selectable icon, or a double arrow button, for example.

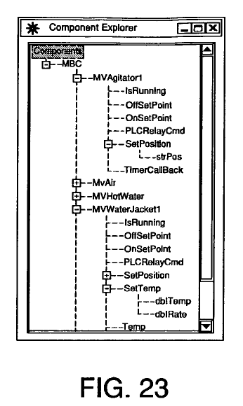

Upon selection of components, selected components may be explored within the IDE, such as through the use of a component explorer window as illustrated in FIG. 23. As illustrated, the component explorer allows for the viewing of properties and methods of each component selected for a recipe project, and these properties and methods may be expandable, such as through the use of a treed menu. Components may additionally be added, or information as to components may be viewed, through selection of components within the component explorer window, for example.

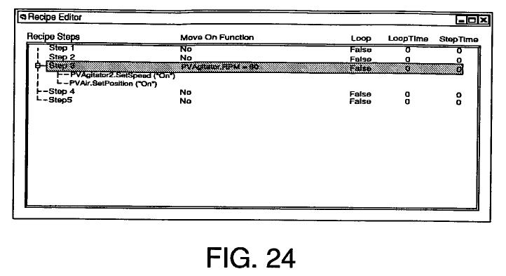

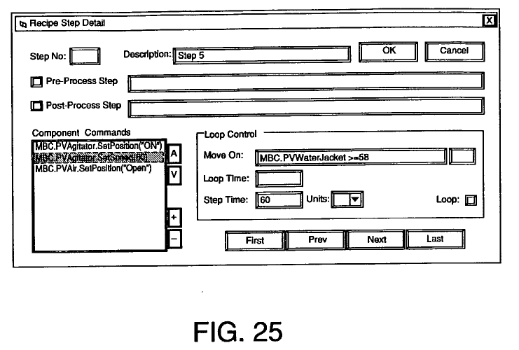

From within, or without, the component explorer, and/or the component selector and browser, a recipe may be edited. A recipe may be edited, for example, through the use of a recipe editor, such as that illustrated in the exemplary screen shot of FIG. 24. A step may be selected within the recipe editor, to which step a component is to be added. Upon selection of a given step, the components then involved in that step may be displayed, such as through the use of a treed menu. Further, selected aspects of that step and/or those components, may be displayed. Further, upon selection of a step, a step detail window may be available, as, for example, a pop-up window, or a selectable display window from, for example, a file menu or a hyperlink. Upon selection of a step detail window, such as that illustrated in exemplary screen shot of FIG. 25, numerous aspects of the step may be illustrated. These aspects may include, for example, components included in the step, component commands included in the step, the number of the step, pre and post processing for the step, loop control for the step, and the ability to move, within the step detail window, between steps. It may also be allowable to enable and/or disable recipe steps, such as from within the recipe step detail. Further, multiple recipe steps may be block selected by methodologies apparent to those skilled in the art.

Those of ordinary skill in the art will recognize that many modifications and variations of the present invention may be implemented. The foregoing description and the following claims are intended to cover all such modifications and variations.

1. A model based controller system, comprising:
at least one model including at least one process step;
at least one controller that generates at least one control command;
at least one component responsive to the at least one control command,
wherein said at least one component receives the at least one control command from said at least one controller, and wherein said at least one component sends at least one component information element to said at least one controller; and
at least one communicative coordination that communicatively coordinates said at least one model with said at least one controller, wherein the at least one control command is generated in accordance with the at least one process step, and wherein at least one of the at least one process step is varied in accordance with the at least one component information element.

2. The system of claim 1, wherein said coordination of said at least one model with said at least one controller comprises a data flow control between said at least one model and said at least one controller.

3. The system of claim 1, wherein said controller is adapted to control at least two of said at least one component.

4. The system of claim 1, wherein said at least one model comprises a development mode.

5. The system of claim 1, wherein said at least one model comprises an execution mode.

6. The system of claim 1, further comprising at least one recipe generator communicatively coupled to said at least one model.

7. The system of claim 1, further comprising at least one server being communicatively coupled to said controller.

8. The system of claim 1, further comprising at least one server being communicatively coupled to said model.

9. The system of claim 1, wherein said coordination comprises a server.

10. The system of claim 5, further comprising computing resources for real-time control in said execution mode.

11. The system of claim 1, wherein said component comprises at least one operative component selected from the group consisting of a valve, a sensor, and a motor.

12. The system of claim 1, wherein said controller comprises at least one programmable logic controller.

13. The system of claim 12, wherein said coordination comprises code for enabling communications.

14. The system of claim 13, wherein said coordination comprises code for modifying at least one recipe associated with said controller.

15. The system of claim 14, wherein said code is responsive to said at least one model.

16. The system of claim 4, wherein said coordination comprises code for creating at least one recipe associated with said model in said development environment.

17. The system of claim 16, wherein said code is responsive to said at least one model in an execution environment.

18. The system of claim 1, further comprising at least one interface for presenting information indicative of said at least one component and said at least one model to a user.

19. The system of claim 18, further comprising code for enabling said user to use said interface to modify said at least one model.

20. The system of claim 19, further comprising code for modifying said at least one model.

21. The system of claim 20, wherein said code for modifying said at least one model is adapted to enable a user to view and edit said at least one model being operated by said at least one controller.

22. The system of claim 21, further comprising at least one component browser for presenting information indicative of said at least component to enable user selection of said at least one component by said code for modifying said at least one model.

23. The system of claim 22, wherein said at least one component browser comprises code for presenting information indicative of said at least one component in a hierarchy.

24. The system of claim 23, wherein said at least one component browser comprises code for information indicative of operation of said at least one controller by said at least one model.

25. The system of claim 24, further comprising code for simulating operation of said at least one controller.

26. The system of claim 25, wherein said code for simulating comprises data for simulating said at least one component.

27. The system of claim 26, wherein said simulator outputs code indicative of said at least one model.

28. The system of claim 1, wherein said at least one component comprises at least one simulated component.

29. A method of controlling a process, using a model based controller system, comprising:
generating at least one model, including at least one process step;
issuing at least one control command from the at least one controller;
receiving, by at least one component, of the at least one control command from said at least one controller;
sending by the at least one component, responsively to the at least one control command, of at least one component information element to the at least one controller; and
communicatively coordinating the at least one model with the at least one controller, wherein the at least one control command is generated in accordance with the at least one process step, and wherein the at least one process step is varied in accordance with the at least one component information element.

30. A computer-readable medium carrying thereon one or more sequences of instructions for controlling a physical process, wherein execution of the one or more sequences of instructions by one or more processors causes the one or more processors to perform the steps of:
generating at least one model, including at least one process step;
issuing at least one control command from the at least one controller;
receiving, by at least one component, of the at least one control command from said at least one controller;
sending by the at least one component, responsively to the at least one control command, of at least one component information element to the at least one controller; and
communicatively coordinating the at least one model with the at least one controller, wherein the at least one control command is generated in accordance with the at least one process step, and wherein the at least one process step is varied in accordance with the at least one component information element.
